(19) United States
(12) Patent Application Publication
(10) Pub. No.: US 2025/0330956 A1
(43) Pub. Date: Oct. 23, 2025

(54) COMMUNICATION SYSTEM, AND COMMUNICATION METHOD

(71) Applicant: Mitsubishi Electric Corporation, Tokyo (JP)

(72) Inventors: Masaki HARUNA, Tokyo (JP); Noriyuki FUKUI, Tokyo (JP); Takeshi IMAI, Tokyo (JP); Fumiki HASEGAWA, Tokyo (JP); Seiji KOZAKI, Tokyo (JP)

(73) Assignee: Mitsubishi Electric Corporation, Tokyo (JP)

(21) Appl. No.: 18/855,653

(22) PCT Filed: Apr. 25, 2022
(86) PCT No.: PCT/JP2022/018743

§ 371 Date: Oct. 10, 2024

(51) Int. Cl. H04W 72/044; H04B 17/318; H04W 72/51

(52) U.S. Cl. CPC H04W 72/044; H04B 17/318; H04W 72/51

(57) ABSTRACT

A communication system according to the present disclosure includes a terminal device, a base station that is one or more communication devices, another one of the terminal devices, and electrical equipment, in which the terminal device includes a wireless communication unit that measures intensity of a radio wave received from the communication device, and an information display unit that displays information indicating radio field intensity by superimposing the information on a display screen corresponding to application software, the information being generated on the basis of a result of measurement performed by the wireless communication unit.

### FIELD

The present disclosure relates to a communication system, a terminal device, a base station, a radio wave state display method, and a program for performing wireless communication.

### BACKGROUND

In recent years, wireless communication has been introduced progressively, and radio waves are used in many places. Meanwhile, since the radio waves are invisible, it is difficult for a user who wants to avoid the radio waves to know where to go to avoid the radio waves.

Patent Literature 1 discloses a technique in which, in order to examine a location of deployment of a base station, a reception device installed on an automobile measures intensity of a carrier signal transmitted from a base station, and a result of the measurement by the reception device is analyzed to determine a region where electric field intensity is weak. Using the technique described in Patent Literature 1 can obtain a distribution of the electric field intensity in a wide area and formulate a base station deployment plan such that a base station is disposed in the area where the electric field intensity is weak.

### CITATION LIST

### Patent Literature

Patent Literature 1: Japanese Patent Application Laid-open No. H11-211768

### SUMMARY OF INVENTION

### Problem to be Solved by the Invention

In the technique described in Patent Literature 1, a business that deploys the base station can know the distribution of the electric field intensity, but a user cannot know the intensity of radio waves. A smartphone or the like displays a mark indicating the intensity of the radio waves, but the display is small and is displayed alone, thereby not being intuitively and easily understood by the user.

The present disclosure has been made in view of the above, and an object of the present disclosure is to provide a communication system that can present information indicating intensity of a radio wave to a user in a way the information is easily understood.

### Means to Solve the Problem

To solve the problem and achieve the object described above, a communication system according to the present disclosure includes: one or more communication devices capable of performing wireless communication; and a terminal device. The terminal device includes: a radio field intensity measuring unit to measure intensity of a radio wave received from the communication device; and an information display unit to display information indicating radio field intensity by superimposing the information on a display screen corresponding to application software, the information being generated on the basis of a result of measurement performed by the radio field intensity measuring unit.

### Effects of the Invention

The communication system according to the present disclosure has an effect that the information indicating the intensity of the radio wave can be presented to the user in the way the information is easily understood.

### BRIEF DESCRIPTION OF DRAWINGS

FIG. 1 is a diagram illustrating an exemplary configuration of a communication system according to a first embodiment.

FIG. 2 is a diagram illustrating an exemplary configuration of a terminal device of the first embodiment.

FIG. 3 is a diagram illustrating an exemplary configuration of a base station of the first embodiment.

FIG. 4 is a sequence diagram illustrating an example of radio wave state display processing in the communication system of the first embodiment.

FIG. 5 is a diagram illustrating a first example of a display screen of radio field intensity on the terminal device of the first embodiment.

FIG. 6 is a diagram illustrating a second example of the display screen of the radio field intensity on the terminal device of the first embodiment.

FIG. 7 is a diagram illustrating a third example of the display screen of the radio field intensity on the terminal device of the first embodiment.

FIG. 8 is a diagram illustrating a fourth example of the display screen of the radio field intensity on the terminal device of the first embodiment.

FIG. 9 is a diagram illustrating an example of display screens corresponding to applications of the terminal device of the first embodiment.

FIG. 10 is a diagram illustrating an exemplary configuration of a computer system that implements the terminal device of the first embodiment.

FIG. 11 is a diagram illustrating an exemplary configuration of a communication system according to a second embodiment.

FIG. 12 is a diagram illustrating an exemplary configuration of a terminal device of the second embodiment.

FIG. 13 is a diagram illustrating an exemplary configuration of a base station of the second embodiment.

FIG. 14 is a sequence diagram illustrating an example of resource sharing processing of the second embodiment.

FIG. 15 is a diagram illustrating an exemplary display of resource information of the second embodiment.

FIG. 16 is a diagram illustrating an exemplary display of a communication speed for each application of the second embodiment.

### DESCRIPTION OF EMBODIMENTS

Hereinafter, a communication system, a terminal device, a base station, a radio wave state display method, and a program according to embodiments will be described in detail with reference to the drawings.

### First Embodiment

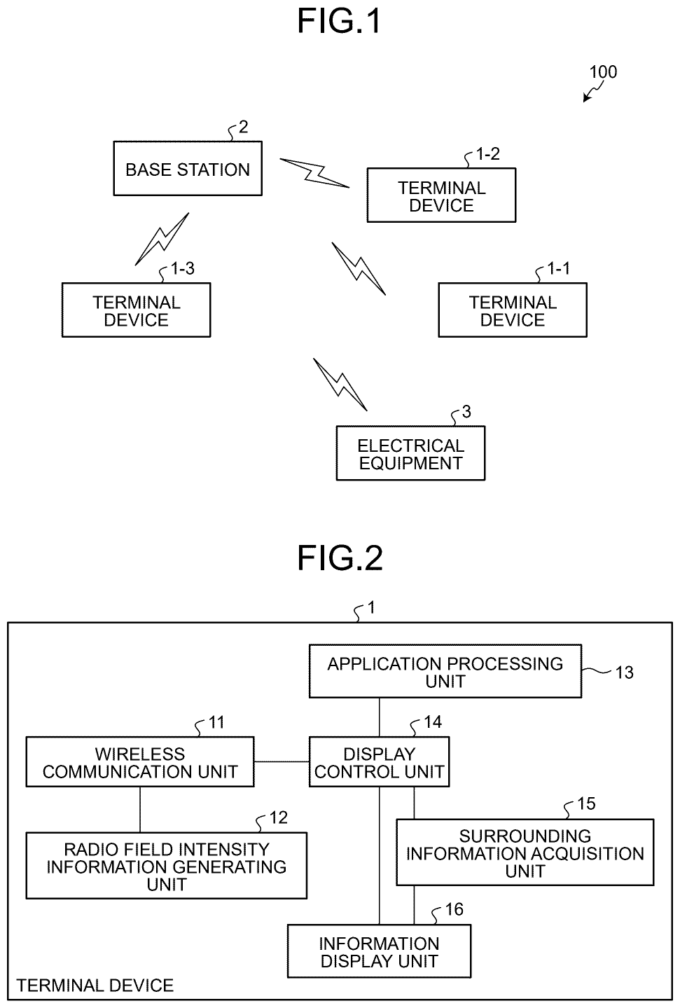

FIG. 1 is a diagram illustrating an exemplary configuration of a communication system according to a first embodiment. A communication system 100 of the present embodiment includes terminal devices 1-1 to 1-3, a base station 2, and electrical equipment 3. The terminal devices 1-1 to 1-3 can perform wireless communication with the base station 2. The electrical equipment 3 is, for example, a home electric appliance (household electric appliance), office equipment, a game machine, industrial equipment, or the like, has a wireless communication function, and can communicate with the base station 2. The base station 2, the terminal devices 1-1 to 1-3, and the electrical equipment 3 are each an example of a communication device capable of performing wireless communication. Hereinafter, the terminal devices 1-1 to 1-3 will be referred to as terminal devices 1 when not distinguished individually.

The base station 2 may be, for example, a base station in a wireless local area network (LAN) conforming to a standard such as Wi-Fi (registered trademark), a base station in a mobile phone network, or a base station in other wireless communication. Also, although FIG. 1 illustrates the base station 2 as one station, the terminal devices 1 as three devices, and the electrical equipment 3 as one equipment, the numbers of the base station 2, the terminal devices 1, and the electrical equipment 3 are not limited to the example illustrated in FIG. 1. Moreover, the communication system 100 need not include the electrical equipment 3. Furthermore, the base station 2 may be capable of communicating with another one of the base stations 2 not illustrated in FIG. 1.

In addition, the terminal devices 1 are, for example, mobile communication devices such as smartphones, tablets, or personal computers, but some of the terminal devices 1 may be deployed in a fixed location. Also, although FIG. 1 illustrates an example of the communication system 100 at a certain time point, the devices included in the communication system 100 may be changed due to the movement of the terminal devices 1, the addition, movement, and/or removal of the base station 2, the addition, movement, and/or removal of the electrical equipment 3, and the like.

The terminal devices 1 of the present embodiment measure reception intensity of radio waves and display a result of the measurement by, for example, superimposing the result of the measurement on a video of the surrounding of a user, thereby presenting information indicating the reception intensity to the user in a way that the information is easily understood. As a result, for example, a user who desires to avoid radio waves can move while checking a display screen on the terminal device 1 and move to a place where the radio field intensity is weak. Conversely, a user who is about to establish communication can move while checking the display screen on the terminal device 1 and move to a place where the radio field intensity is strong. In addition, when the radio field intensity is displayed in accordance with application software used by a user, information indicating the intensity of radio waves can be provided to the user in accordance with the situation of use. Details of a method of displaying the radio field intensity in the present embodiment will be described later.

FIG. 2 is a diagram illustrating an exemplary configuration of the terminal device 1 of the present embodiment. As illustrated in FIG. 2, the terminal device 1 includes a wireless communication unit 11, a radio field intensity information generating unit 12, an application processing unit 13, a display control unit 14, a surrounding information acquisition unit 15, and an information display unit 16.

The wireless communication unit 11 can perform wireless communication with the base station 2. The wireless communication unit 11 also has a function as a radio field intensity measuring unit that measures intensity of a radio wave received from the communication device. In the example illustrated in FIG. 2, the wireless communication unit 11 has the function as the radio field intensity measuring unit, but the radio field intensity measuring unit may be provided separately from the wireless communication unit 11.

The radio field intensity information generating unit 12 generates radio field intensity information that is information for notifying the base station 2 of the reception intensity measured by the wireless communication unit 11, and outputs the generated radio field intensity information to the wireless communication unit 11. The wireless communication unit 11 transmits the radio field intensity information to the base station 2. The radio field intensity information includes information indicating the measured reception intensity and location information indicating the location of the terminal device 1. The result of measurement of the reception intensity may be obtained for each frequency, in which case the radio field intensity information includes information indicating the reception intensity for each frequency. The location information is, for example, calculated by a location information calculation unit (not illustrated) in the terminal device 1, and the location information calculation unit notifies the radio field intensity information generating unit 12 of the location information. The location information calculation unit may calculate the location information by, for example, global positioning satellite (GPS) positioning using a signal received by a GPS antenna, or another positioning method such as positioning using radio waves of a plurality of the base stations 2 or positioning using beacons, radio frequency identification (RFID), or the like. Also, the radio field intensity information generating unit 12 may have a function as the location information calculation unit.

The information display unit 16 displays various types of information such as characters, images, and videos under the control of the display control unit 14. As described later, the information display unit 16 displays, for example, information indicating the radio field intensity, which is generated on the basis of the result of measurement by the wireless communication unit 11, by superimposing the information on a display screen corresponding to application software (hereinafter also referred to as an application). Furthermore, the information display unit 16 may also have a function as an input receiving unit that receives user's input, or the input receiving unit may be provided separately from the information display unit 16.

The application processing unit 13 executes processing corresponding to the application software installed in the terminal device 1. In a case where a plurality of applications is installed, the application processing unit 13 executes processings corresponding to the respective applications. The application processing unit 13 generates application display information that is information for performing display corresponding to the application, and outputs the generated display information to the display control unit 14.

The display control unit 14 outputs the application display information received from the application processing unit 13 to the information display unit 16, thereby causing the information display unit 16 to perform display corresponding to the display information. In addition, the display control unit 14 may use the application display information received from the application processing unit 13 and the radio field intensity received from the wireless communication unit 11 to generate display information for superimposing and displaying the information indicating the radio field intensity on the display screen of the application corresponding to the application processing unit 13, and output the display information to the information display unit 16. As a result, the information display unit 16 can display the information indicating the radio field intensity by superimposing the information on the screen corresponding to the application. When receiving map information indicating a distribution of the radio field intensity from the base station 2 via the wireless communication unit 11, the display control unit 14 may generate display information for displaying the map information and output the display information to the information display unit 16. In addition, the display control unit 14 may generate display information for superimposing and displaying the map information on the display screen of the application corresponding to the application processing unit 13, and output the display information to the information display unit 16.

The surrounding information acquisition unit 15 includes, for example, a camera and forms an image of a target such as an object around the terminal device 1 via a lens to acquire surrounding information that is information of the surroundings as an image or a video, thereby outputting the acquired surrounding information to the display control unit 14. As a result, the display control unit 14 uses the surrounding information received from the surrounding information acquisition unit 15 and the radio field intensity received from the wireless communication unit 11 to be able to generate display information for superimposing and displaying the information indicating the radio field intensity on the display screen that displays the image or video of the surroundings. Moreover, by outputting the image or video as the surround information to the information display unit 16, the surrounding information acquisition unit 15 can cause the information display unit 16 to display the image or video as it is. Note that, since the surrounding information acquisition unit 15 is implemented by, for example, the camera and an application for performing photographing using the camera, the surrounding information can also be regarded as an example of the application display information.

Note that although the terminal devices 1 as three devices are illustrated in FIG. 1, only one or more of the terminal devices 1 illustrated in FIG. 2 need be able to display the information indicating the radio field intensity by superimposing the information on the application display information, and the rest of the terminal devices need not be the terminal device 1 illustrated in FIG. 2 and may be a communication device such as a general smartphone that communicates with the base station 2. For example, when the terminal device 1-1 illustrated in FIG. 1 is the terminal device of a user who wants to check the intensity of radio waves, a general communication device may be present instead of the terminal devices 1-2 and 1-3. Moreover, the electrical equipment 3 may include the terminal device 1, and the electrical equipment 3 may perform an operation similar to that of the terminal device 1. The communication system 100 need only include, for example, one or more of the communication devices capable of performing wireless communication and the terminal device 1-1, and the communication device is not limited to the base station 2, the terminal devices 1-2 and 1-3, and the electrical equipment 3.

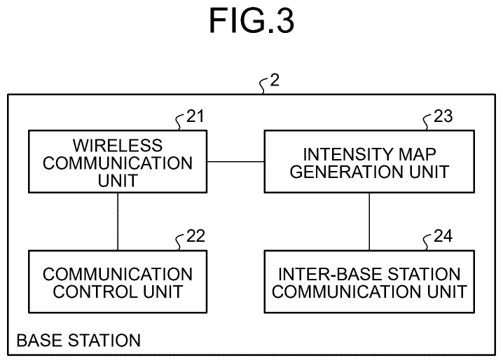

FIG. 3 is a diagram illustrating an exemplary configuration of the base station 2 of the present embodiment. As illustrated in FIG. 3, the base station 2 includes a wireless communication unit 21, a communication control unit 22, an intensity map generation unit 23, and an inter-base station communication unit 24. Note that FIG. 3 illustrates the exemplary configuration of the base station 2 capable of communicating with another one of the base stations 2, but in a case where communication between the base stations 2 is not performed, the base station 2 need not include the inter-base station communication unit 24.

The wireless communication unit 21 can perform wireless communication with the communication device such as the terminal device 1 and the electrical equipment 3 under the control of the communication control unit 22. Upon receiving the radio field intensity information from the terminal device 1, the wireless communication unit 21 outputs the radio field intensity information received to the intensity map generation unit 23. Also, upon receiving the map information from the intensity map generation unit 23, the wireless communication unit 21 transmits the map information to the terminal device 1. Moreover, upon receiving wide-area map information, which will be described later, from the intensity map generation unit 23, the wireless communication unit 21 transmits the wide-area map information to the terminal device 1.

The communication control unit 22 controls communication between the base station 2 and a communication device accommodated by the base station 2. The communication device accommodated by the base station 2 is, for example, a communication device that establishes wireless connection with the base station 2 by performing predetermined connection processing and performs wireless communication with the base station 2. The communication control unit 22 may allocate a radio resource to the communication device accommodated by the base station 2. The radio resource is, for example, at least one of a time and a band (frequency range) used in the wireless communication.

The intensity map generation unit 23 uses the radio field intensity information received from the wireless communication unit 21 to generate a radio field intensity map indicating a distribution of the radio field intensity, and outputs the map information indicating the radio field intensity map to the wireless communication unit 21 and the inter-base station communication unit 24. Moreover, when receiving local map information generated by another one of the base stations 2 from the inter-base station communication unit 24, the intensity map generation unit 23 generates the wide-area map information by integrating the local map information received and the map information that the intensity map generation unit 23 has generated, and outputs the wide-area map information generated to the wireless communication unit 21.

The inter-base station communication unit 24 performs communication between the base stations 2. A communication line of the communication between the base stations may be a wired line, a wireless line, or a mixture of wired and wireless lines. The base station 2 can communicate with another one of the base stations 2 not illustrated in FIG. 1. The inter-base station communication unit 24 transmits the map information received from the intensity map generation unit 23 to the other one of the base stations 2 as the local map information. Moreover, the inter-base station communication unit 24 receives the local map information generated by the other one of the base stations 2 from the other one of the base stations 2, and outputs the local map information received to the intensity map generation unit 23.

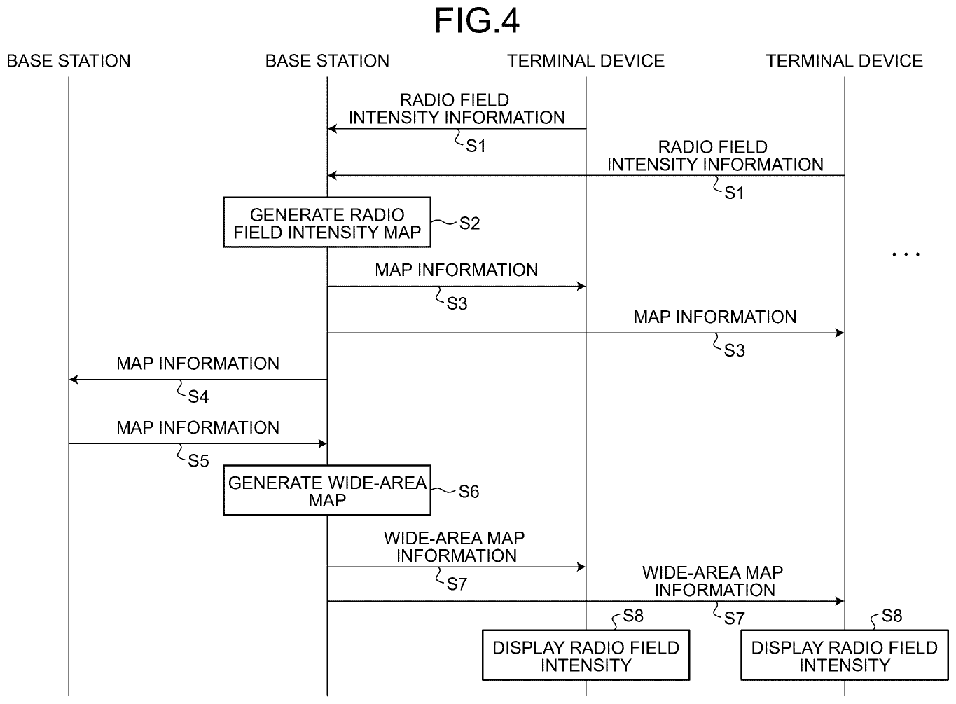

Next, the operation of the present embodiment will be described. FIG. 4 is a sequence diagram illustrating an example of radio wave state display processing in the communication system of the present embodiment. As illustrated in FIG. 4, the terminal devices 1 each transmit the radio field intensity information to the base station 2 (step S1). As described above, the radio field intensity information includes the information indicating the reception intensity on the terminal device 1 and the location information of the terminal device 1. Note that FIG. 4 illustrates an example in which the base station 2 that is the second base station from the left accommodates the terminal devices 1 illustrated in FIG. 4.

The base station 2 generates the radio field intensity map (step S2). Specifically, the intensity map generation unit 23 uses the location information in the radio field intensity information transmitted from the terminal devices 1 accommodated by the base station 2 to obtain, as the radio field intensity map, a local radio field intensity distribution in a range where communication can be established with the base station 2, and generates the map information indicating the radio field intensity map. The map information may be a list of combinations of the location and the radio field intensity (reception intensity) of each of the terminal devices 1, may be information indicating a propagation model of a radio wave transmitted from the base station 2, or may be both of them. The propagation model is obtained by, for example, using the location of the base station 2 and the location and radio field intensity of the terminal devices 1 and estimating the intensity of the radio wave transmitted from the base station 2 and propagating in each direction for each distance from the base station 2. Note that the location of the base station 2 may be held in advance in the base station 2, or the base station 2 may have a positioning function as with the terminal devices 1 and calculate the location using the positioning function. In a case where the map information is the information indicating the propagation model, the map information may indicate the radio field intensity corresponding to a direction and a distance from the base station 2 by a calculation formula, or may indicate the radio field intensity for each mesh indicating a location. In addition, in a case where the wireless communication unit 21 of the base station 2 includes a plurality of antenna elements and can estimate relative locations, that is, relative directions and distances of the terminal devices 1 from the base station 2, the map information may be generated using a result of estimation of the relative locations and the radio field intensities of the terminal devices 1 instead of the location information in the radio field intensity information.

The base station 2 transmits the map information to the terminal devices 1 (step S3). Also, the base station 2 transmits the map information (local map information) to another one of the base stations 2 (step S4). In FIG. 4, as the other one of the base stations 2, the base station 2 being a single station is illustrated at the far left, but a plurality of the other ones of the base stations 2 may be present.

In addition, the base station 2 receives the map information (local map information) from the other one of the base stations 2 (step S5). The base station 2 uses the map information generated by itself and the map information received from the other one of the base stations 2 to generate a wide-area map that is a map of the radio field intensity in a wide area (step S6). In a case where the pieces of the map information (local map information) are the lists of the location and the radio field intensity, the wide-area map information may be a list obtained by integrating those lists, or may be the radio field intensity for each mesh indicating a location calculated by interpolation or the like from the location and the radio field intensity. In a case where the pieces of the map information are the information indicating the propagation models, the wide-area map information may be information in which the pieces of the map information are superimposed to indicate the propagation models. The method of generating the wide-area map information is not limited to these examples. The map information (local map information) and the wide-area map information are examples of the information indicating the intensity of the radio waves.

The base station 2 transmits the wide-area map information indicating the wide-area map to the terminal devices 1 (step S7). The terminal devices 1 each display the radio field intensity (step S8). Specifically, for example, the terminal device 1 displays the radio field intensity when receiving, from a user, an input that starts an application for displaying the radio field intensity. When receiving an input that starts another application from a user, the terminal device 1 may superimpose the information indicating the radio field intensity in accordance with the content of display of the other application. The terminal device 1 may superimpose and display the information indicating the radio field intensity measured by the terminal device 1 itself on the surrounding information, may superimpose and display the map information received from the base station 2 on the surrounding information, or may superimpose and display the wide-area map information received from the base station 2 on the surrounding information. In addition, the terminal device 1 may use the application display information corresponding to the application and corresponding information of the information indicating the radio field intensity, the map information, or the wide-area map information to superimpose and display the information indicating the intensity of the radio wave on a display screen corresponding to the application. Note that the procedure illustrated in FIG. 4 is an example, and the order of the processing and the like are not limited to the example illustrated in FIG. 4. For example, displaying of the radio field intensity is not limited to step S8, and may be performed at any timing after the information necessary for the display is obtained.

As described above, in the case where the plurality of the terminal devices 1 is present, each of the plurality of the terminal devices 1 transmits the radio field intensity information indicating the result of measurement of the radio field intensity to the base station 2, and the base station 2 generates the map information indicating the distribution of the radio field intensity using the radio field intensity information received from the plurality of the terminal devices 1 and transmits the map information to at least one of the terminal devices 1. Then, the information display unit 16 of the terminal device 1 that has received the map information superimposes and displays the map information on the display screen corresponding to the application. Furthermore, the base station 2 transmits the map information to the other one of the base stations 2, and when receiving the map information generated by the other one of the base stations 2 therefrom, the base station 2 uses the map information received and the map information generated to generate the wide-area map information indicating the distribution of the radio field intensity in the wide area, and transmits the wide-area map information to at least one of the terminal devices 1. The information display unit 16 of the terminal device 1 that has received the wide-area map information superimposes and displays the wide-area map information on the display screen corresponding to the application.

Note that in a case where the radio field intensity information includes the information indicating the reception intensity (radio field intensity) for each frequency, the map information and the wide-area map information are also created for each frequency. In this case, for example, the radio field intensity, the map information, the wide-area map information, and the like corresponding to the frequency selected by a user are displayed.

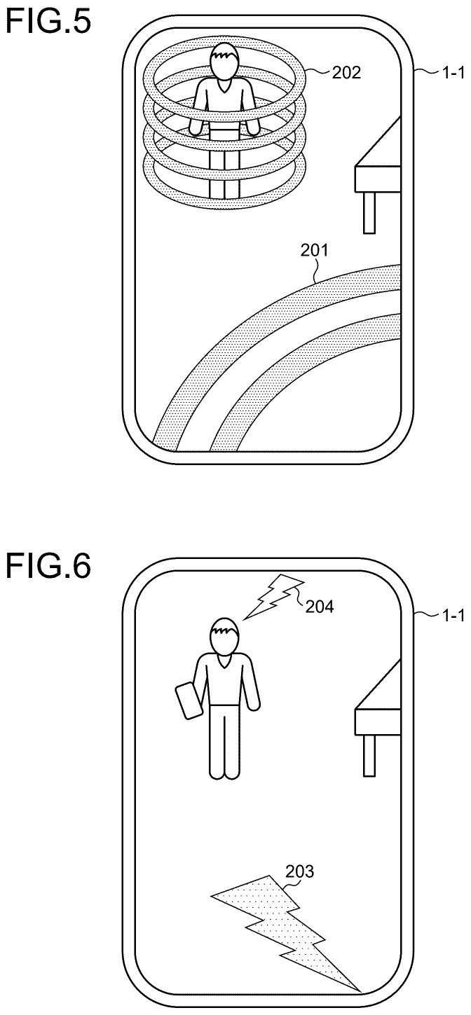

FIG. 5 is a diagram illustrating a first example of the display screen of the radio field intensity on the terminal device 1-1 of the present embodiment. In the example illustrated in FIG. 5, the display control unit 14 of the terminal device 1-1 uses the surrounding information and the map information to generate display information for superimposing and displaying the intensity of radio waves on an image of the surrounding, and the information display unit 16 displays the display information. Images 201 and 202 illustrated in FIG. 5 are stereoscopic rings simulating imagery of the radio waves and displayed using augmented reality (AR). The image 201 indicates the radio field intensity corresponding to the terminal device 1-1 itself displaying the display screen illustrated in FIG. 5, and the image 202 indicates the radio field intensity corresponding to another one of the terminal devices 1. In the example illustrated in FIG. 5, the map information is the information including the location and the radio field intensity of each of the terminal devices 1, and the display control unit 14 uses the image acquired as the surrounding information and the location of the terminal device 1-1 to detect a person present at the location corresponding to the terminal device 1-1 in the surrounding information, and generate the display information such that the image 202 is displayed around the person. Also, the display control unit 14 uses the radio field intensity corresponding to the terminal device 1-1 itself displaying the display screen illustrated in FIG. 5 to generate the display information for displaying the image 201 around the terminal device 1-1. In the example illustrated in FIG. 5, the radio field intensity is indicated by the number of the rings, and the larger the number of the rings, the stronger the intensity of the radio wave.

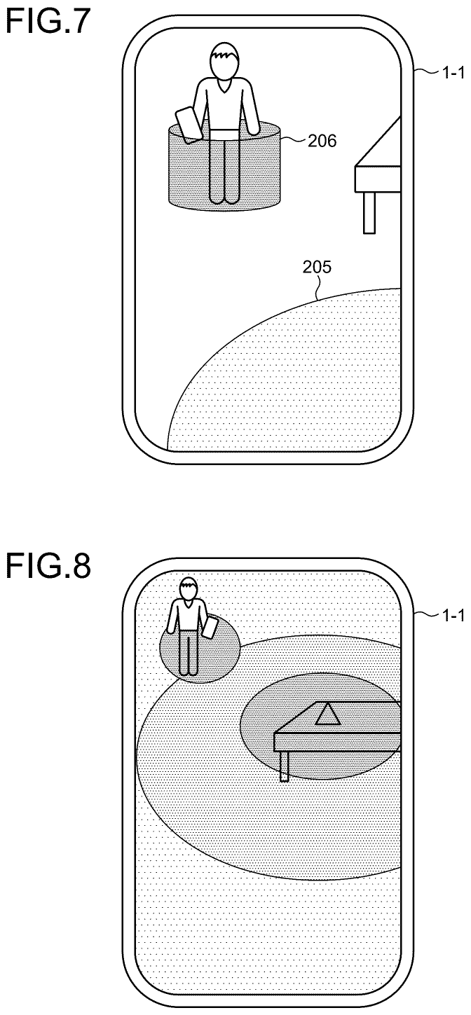

FIG. 6 is a diagram illustrating a second example of the display screen of the radio field intensity on the terminal device 1-1 of the present embodiment. FIG. 7 is a diagram illustrating a third example of the display screen of the radio field intensity on the terminal device 1-1 of the present embodiment. In the examples illustrated in FIGS. 6 and 7, as with the example illustrated in FIG. 5, the display control unit 14 of the terminal device 1-1 uses the surrounding information and the map information including the location and the radio field intensity of each of the terminal devices 1 to generate display information for superimposing and displaying the intensity of radio waves on an image of the surrounding, and the information display unit 16 displays the display information. In the example illustrated in FIG. 6, images 203 and 204 are figures representing imagery of the radio waves, and indicate the intensity of the radio waves by a difference in color. In the example illustrated in FIG. 7, images 205 and 206 are figures representing imagery of the radio waves and displayed using AR, and indicate the intensity of the radio waves by a difference in color. The images 203 and 205 indicate the radio field intensity corresponding to the terminal device 1-1 itself displaying the display screen, and the images 204 and 206 indicate the radio field intensity corresponding to another one of the terminal devices 1.

FIG. 8 is a diagram illustrating a fourth example of the display screen of the radio field intensity on the terminal device 1-1 of the present embodiment. In the example illustrated in FIG. 8, the display control unit 14 of the terminal device 1-1 uses the surrounding information and the map information to generate display information for superimposing and displaying the intensity of radio waves on an image of the surrounding, and the information display unit 16 displays the display information. In the example illustrated in FIG. 8, the map information is the radio field intensity for each mesh indicating the location, and the radio field intensity is indicated by a difference in color. In FIG. 8, the intensity of the radio waves is indicated by the difference in color, but the intensity of the radio waves may be indicated by the height of a three-dimensional shape displayed using AR.

In FIG. 5 to FIG. 8, the radio field intensity is indicated by the figures, the colors, and the like, but a numerical value indicating the radio field intensity may also be superimposed and displayed together with the corresponding figure, color, and the like. Moreover, whether or not to superimpose and display the numerical value indicating the radio field intensity may be switched by user's selection to implement the display.

Note that FIG. 5 to FIG. 8 are examples, and a specific method of displaying the intensity of the radio waves, the figures indicating the radio waves, and the like are not limited to these examples. In addition, the terminal device 1-1 can display the intensity of the radio waves by a plurality of display methods, and may change the display according to user's selection. For example, the display of FIG. 6 to FIG. 8 may be switched by user's selection.

In addition, in FIG. 5 to FIG. 8, the examples in which the map information is superimposed on the surrounding information have been described, but only the radio field intensity measured by the terminal device 1-1 itself may be superimposed on the surrounding information. For example, only the image 201 in the example illustrated in FIG. 5 may be superimposed on the surrounding information, only the image 203 in the example illustrated in FIG. 6 may be superimposed on the surrounding information, or only the image 205 in the example illustrated in FIG. 7 may be superimposed on the surrounding information. Moreover, whether to display only the radio field intensity measured by the terminal device 1-1 itself or display the map information may be switched by user's selection. Note that, in a case where the terminal device 1-1 displays only the radio field intensity measured by the terminal device 1-1 itself, the base station 2 does not need to generate the map information.

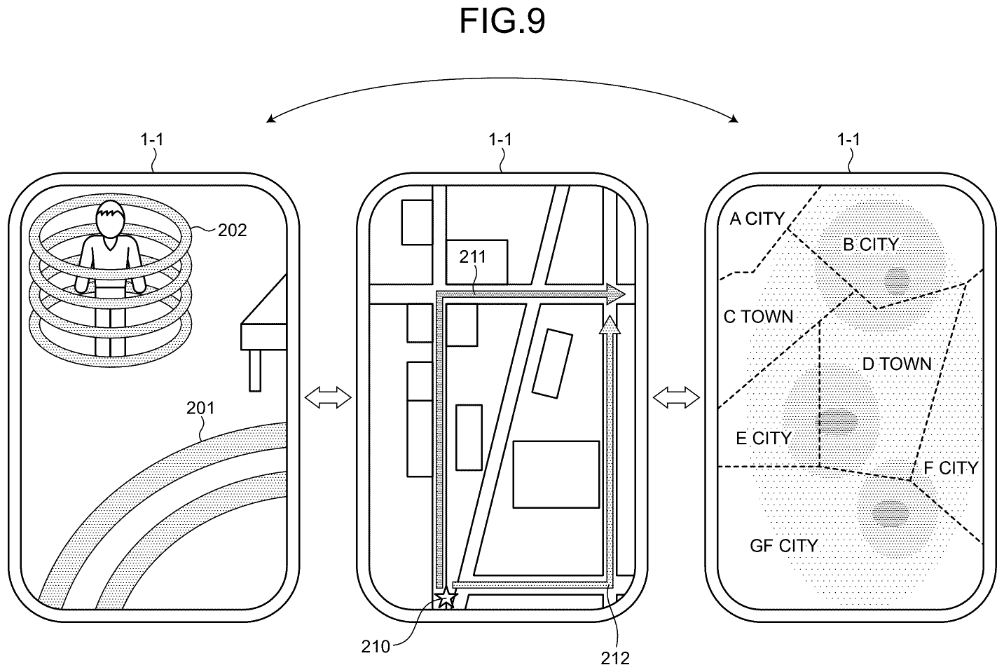

Although FIG. 6 to FIG. 8 illustrate the examples in which the radio field intensity is superimposed on the surrounding information, the display control unit 14 may change the method of displaying the radio field intensity in accordance with an application used by the user. FIG. 9 is a diagram illustrating an example of display screens corresponding to applications of the terminal device 1-1 of the present embodiment. In the example illustrated in FIG. 9, the applications are an application for displaying the radio field intensity, a route guidance application, and a map application. The display screen at the far left of FIG. 9 is similar to the example illustrated in FIG. 5, and is displayed when the user starts the application for checking the surrounding radio field intensity.

The center of FIG. 9 illustrates the display screen of the route guidance application, and is the display screen for guiding a route on foot, for example. The display screen at the center of FIG. 9 is displayed, for example, by activating the route guidance application and performing input that indicates selection of route guidance with radio wave information taken into consideration. The display screen at the center of FIG. 9 displays a current location 210 of the terminal device 1-1, a route 211 with high radio field intensity, and a route 212 with low radio field intensity. In the example illustrated at the center of FIG. 9, the application for route guidance generates the routes using the map information. The terminal device 1-1 may thus link the map information indicating the radio field intensity and the like with processing in the application. For example, the display control unit 14 outputs the map information to the application processing unit 13, and the application processing unit 13 obtains an integrated value of the intensity of the radio wave per mesh indicating the location, that is, per unit area for each route on the basis of the map information and cartographic information for route guidance. Then, on the basis of the current location of the terminal device 1-1 and the integrated value, the application processing unit 13 determines route information indicating the route with high radio field intensity and route information indicating the route with low radio field intensity, and notifies the display control unit 14 of the determined result, the current location, and the cartographic information, whereby the display control unit 14 generates the display information for displaying the display screen illustrated at the center of FIG. 9 on the basis of the cartographic information, the current location, and the route information, and outputs the display information to the information display unit 16. As a result, the information display unit 16 can superimpose and display the cartographic information, the current location 210, the route 211 with high radio field intensity, and the route 212 with low radio field intensity. The current location is calculated by, for example, the location information calculation unit (not illustrated) as described above.

The display screen at the far right of FIG. 9 is of the map application and displays a map of a range wider than the range illustrated on the display screen at the center of FIG. 9. For example, the display screen at the far right of FIG. 9 is displayed by activating the map application and selecting wide-area display. On the display screen at the far right of FIG. 9, the wide-area map information as a color-coded distribution map is superimposed on the cartographic information of the wide area. In addition, on the display screen of the narrow area illustrated at the center of FIG. 9, the map information may be superimposed as a color-coded distribution map similarly to the wide-area map information on the display screen at the far right of FIG. 9. In addition, when a range wider than the range illustrated in FIG. 9 is displayed in the route guidance application, the wide-area map information may be superimposed and displayed similarly to the display screen at the far right of FIG. 9. Note that the method of displaying the map information and the wide-area map information is not limited to the example illustrated in FIG. 9. Also, the method of displaying the routes is not limited to the example illustrated in FIG. 9.

The display screens illustrated in FIG. 9 are switched as appropriate by a user's operation such as activation of the application or selection of a display area. As described above, depending on the application display screen, the terminal device 1-1 can select information suitable for the application display screen from among the information indicating the reception intensity of the terminal device 1-1 itself, the map information, and the wide-area map information, and display the information selected. Therefore, the terminal device 1-1 can display the information indicating the radio field intensity in accordance with the situation of use by the user. FIG. 9 illustrates the route guidance application, but the application in which the radio field intensity is reflected is not limited thereto. Furthermore, in a case where the radio field intensity is measured for each frequency as described above, the frequency may be selected by a user's operation, and information indicating the radio field intensity corresponding to the selected frequency may be displayed.

Note that, in the example described above, the base station 2 generates the map information, but in a case where the terminal device 1 has the function of performing communication between the terminal devices 1, the terminal device 1 may generate the map information by receiving the radio field intensity information from another one of the terminal devices 1. The communication between the terminal devices 1 may be performed by the wireless communication unit 11 in a communication mode different from that of the communication with the base station 2, or may be performed by another communication scheme different from that of the wireless communication unit 11 by the terminal device 1 including a wireless communication unit that performs communication by the other communication scheme different from that of the wireless communication unit 11. The other communication scheme may be, for example, a short-range wireless communication scheme such as Bluetooth (registered trademark), a communication scheme called low power wide area (LPWA) capable of performing communication over a long distance and a wide range with less power, or another scheme. Furthermore, a plurality of the other communication schemes may be used where, for example, the terminal device 1 may be compatible with both Bluetooth (registered trademark) and LPWA communication scheme. In this case, for example, the terminal device 1 may perform communication by Bluetooth (registered trademark) in a case where the distance between the terminal devices 1 is equal to or less than the maximum distance over which communication can be performed by Bluetooth (registered trademark), and perform communication by the LPWA communication scheme in a case where the distance between the terminal devices 1 is longer than the maximum distance over which communication can be performed by Bluetooth (registered trademark).

Moreover, a base station control device (not illustrated) that manages a plurality of the base stations 2 may acquire the map information from each of the base stations 2 and generate the wide-area map information using the acquired map information. In this case, the base station control device transmits the wide-area map information to each of the base stations 2, and each of the base stations 2 transmits the wide-area map information received from the base station control device to the terminal device 1.

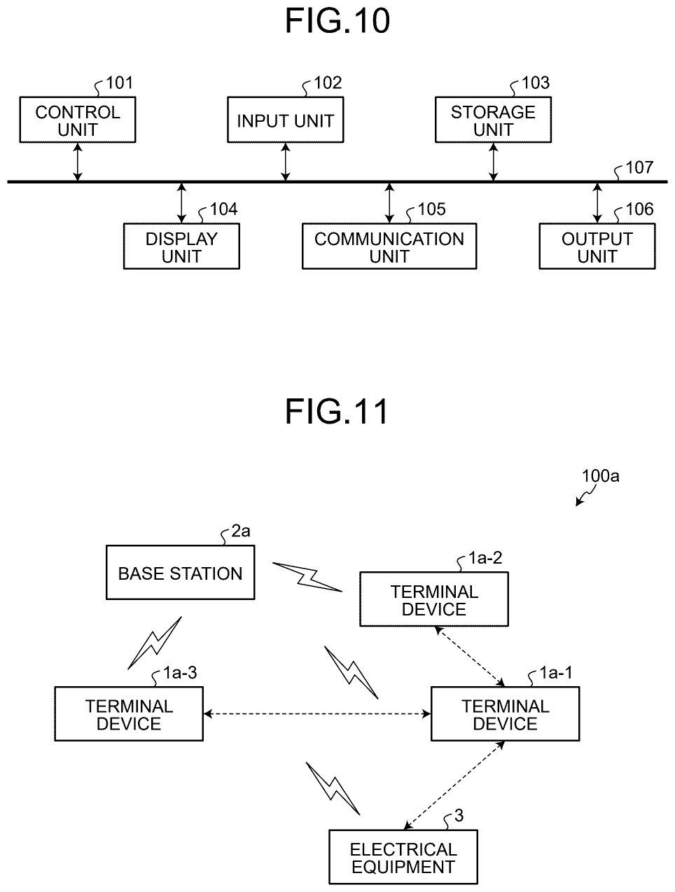

Next, a hardware configuration of the terminal device 1 of the present embodiment will be described. As the hardware configuration of the terminal device 1 of the present embodiment, a computer system runs a program that is a computer program describing the processing of the terminal device 1, whereby the computer system functions as the terminal device 1. FIG. 10 is a diagram illustrating an exemplary configuration of the computer system that implements the terminal device 1 of the present embodiment. As illustrated in FIG. 10, the computer system includes a control unit 101, an input unit 102, a storage unit 103, a display unit 104, a communication unit 105, and an output unit 106, which are connected via a system bus 107. The control unit 101 and the storage unit 103 constitute a processing circuit. Note that the terminal device 1 also includes the camera not illustrated in FIG. 10, and in a case of performing positioning, the terminal device 1 includes a GPS receiver or the like that performs GPS positioning.

In FIG. 10, the control unit 101 is, for example, a processor such as a central processing unit (CPU), and executes the program describing the processing of the terminal device 1 of the present embodiment. Note that a part of the control unit 101 may be implemented by dedicated hardware such as a graphics processing unit (GPU) or a field-programmable gate array (FPGA). The input unit 102 includes, for example, a keyboard, a mouse, and the like and is used by a user of the computer system to input various information. The storage unit 103 includes various memories such as a random access memory (RAM) and a read only memory (ROM) as well as a storage device such as a hard disk, and stores the program to be executed by the control unit 101, necessary data obtained in the course of processing, and the like. The storage unit 103 is also used as a temporary storage area for the program. The display unit 104 includes a display, a liquid crystal display (LCD) panel, and the like and displays various screens to the user of the computer system. Note that the display unit 104 and the input unit 102 may be integrated and implemented by a touch panel or the like. The communication unit 105 is a receiver and a transmitter that perform communication processing. The communication unit 105 may include a plurality of devices corresponding to a plurality of communication schemes. The output unit 106 is a speaker and the like. Note that FIG. 10 illustrates an example, which does not limit the configuration of the computer system.

Here, a description will be given of an exemplary operation of the computer system to make the program of the present embodiment executable. In the computer system having the above configuration, the computer program is installed to the storage unit 103 from, for example, a compact disc (CD)-ROM or a digital versatile disc (DVD)-ROM set in a CD-ROM drive or a DVD-ROM drive not illustrated. When executed, the program read from the storage unit 103 is stored in a main storage area of the storage unit 103. In this state, the control unit 101 executes the processing as the terminal device 1 of the present embodiment in accordance with the program stored in the storage unit 103.

Note that in the above description, the program describing the processing of the terminal device 1 is provided using the CD-ROM or DVD-ROM as a recording medium, but depending on the configuration of the computer system, the capacity of the program provided, and the like, for example, the program may be provided for use through a transmission medium such as the Internet.

For example, the program of the present embodiment causes the terminal device 1 in the communication system 100 to execute: a measurement step of measuring the intensity of the radio wave received from the communication device; and a display step of superimposing and displaying, on the display screen corresponding to the application software, the information indicating the radio field intensity generated on the basis of the result of measurement performed in the measurement step.

The radio field intensity information generating unit 12, the application processing unit 13, and the display control unit 14 illustrated in FIG. 2 are implemented when the computer program stored in the storage unit 103 illustrated in FIG. 10 is executed by the control unit 101 illustrated in FIG. 10. The radio field intensity information generating unit 12, the application processing unit 13, and the display control unit 14 illustrated in FIG. 2 are implemented by also using the storage unit 103 illustrated in FIG. 10. The wireless communication unit 11 illustrated in FIG. 2 is implemented by the communication unit 105 illustrated in FIG. 10. The surrounding information acquisition unit 15 is implemented by the camera not illustrated in FIG. 10 and the control unit 101 illustrated in FIG. 10. The information display unit 16 is implemented by the display unit 104 illustrated in FIG. 10.

The base station 2 is also a computer system, and may have a configuration similar to that of the computer system illustrated in FIG. 10 or need not include some components illustrated in FIG. 10. For example, the base station 2 need only include the control unit 101, the storage unit 103, and the communication unit 105 among the components illustrated in FIG. 10, and need not include the other components. The communication control unit 22 and the intensity map generation unit 23 illustrated in FIG. 3 are implemented when the computer program stored in the storage unit 103 illustrated in FIG. 10 is executed by the control unit 101 illustrated in FIG. 10. The communication control unit 22 and the intensity map generation unit 23 illustrated in FIG. 3 are implemented by also using the storage unit 103 illustrated in FIG. 10. The wireless communication unit 21 and the inter-base station communication unit 24 illustrated in FIG. 3 are implemented by the communication unit 105 illustrated in FIG. 10.

As described above, the terminal device 1 of the present embodiment measures the reception intensity of the radio wave and displays the result of measurement by superimposing the result of measurement on the application display screen corresponding to the application, thereby being able to present the information indicating the reception intensity to the user in a way that the information is easily understood. In addition, the terminal device 1 selects and displays the map information, which is generated using the results of measurement of the plurality of the terminal devices 1, and the wide-area map information, which is generated on the basis of the plurality of pieces of the map information, in accordance with the application display screen, thereby being able to display the radio field intensity corresponding to the situation of use by the user.

### Second Embodiment

FIG. 11 is a diagram illustrating an exemplary configuration of a communication system according to a second embodiment. A communication system 100a of the present embodiment includes terminal devices 1a-1 to 1a-3, a base station 2a, and the electrical equipment 3. The terminal devices 1a-1 to 1a-3 can perform wireless communication with the base station 2a. The base station 2a, the terminal devices 1a-1 to 1a-3, and the electrical equipment 3 are each an example of a communication device capable of performing wireless communication. Hereinafter, the terminal devices 1a-1 to 1a-3 will be referred to as terminal devices 1a when not distinguished individually.

As with the base station 2 of the first embodiment, the base station 2a may be, for example, a base station in a wireless LAN, a base station in a mobile phone network, or a base station in other wireless communication. A communication service using the base station 2a may be charged or free of charge. In a case where the communication service using the base station 2a is charged, for example, a fee may be set in accordance with the communication traffic, or a fixed fee per unit time may be set. Also, although FIG. 11 illustrates the base station 2a as one station, the terminal devices 1a as three devices, and the electrical equipment 3 as one equipment, the numbers of the base station 2a, the terminal devices 1a, and the electrical equipment 3 are not limited to the example illustrated in FIG. 11. Components having similar functions to those of the first embodiment are denoted by the same reference numerals those of the corresponding components in the first embodiment, and a redundant description will be omitted. Hereinafter, differences from the first embodiment will mainly be described.

In the present embodiment, the terminal device 1a grasps a status of use of radio resources in communication between the other ones of the terminal devices 1a and the base station 2a and, in a case where any of the other ones of the terminal devices 1a can provide the radio resource, requests the other one of the terminal devices 1a to share the radio resource. As a result, the radio resource can be used effectively. Note that the communication subject to sharing of the radio resource may be one or both of upstream communication from the terminal device 1a to the base station 2a and downstream communication from the base station 2a to the terminal device 1a. Note that the sharing of the radio resource may be charged or free of charge. In a case where the sharing is charged, a user of the terminal device 1a who uses the surplus radio resource of the other one of the terminal devices 1a pays a fee to a user of the other one of the terminal devices 1a providing the surplus radio resource.

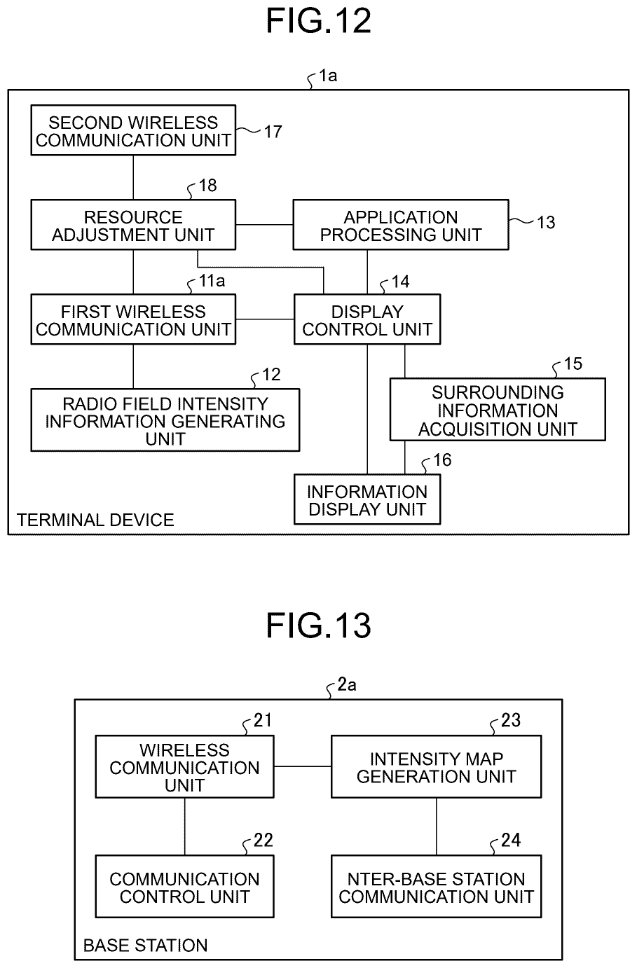

FIG. 12 is a diagram illustrating an exemplary configuration of the terminal device 1a of the present embodiment. As illustrated in FIG. 12, the terminal device 1a is similar to the terminal device 1 of the first embodiment except that a first wireless communication unit 11a is included instead of the wireless communication unit 11 of the terminal device 1 of the first embodiment, and that a second wireless communication unit 17 and a resource adjustment unit 18 are added.

The first wireless communication unit 11a has a function similar to that of the wireless communication unit 11 of the first embodiment and, when receiving an allocation result of the radio resources from the base station 2a, notifies the resource adjustment unit 18 of the allocation result.

The second wireless communication unit 17 can perform communication between the terminal devices 1a (hereinafter also referred to as device to device (D2D) communication) by another communication scheme different from that of the first wireless communication unit 11a. The communication scheme for the communication between the terminal devices 1a may be, for example, a short-range wireless communication scheme such as Bluetooth (registered trademark), a LPWA communication scheme, or another scheme. Also, the other communication scheme may include a plurality of communication schemes where, for example, the terminal device 1a may be compatible with both Bluetooth (registered trademark) and the LPWA communication scheme. In this case, for example, the terminal device 1a may perform communication by Bluetooth (registered trademark) in a case where the distance between the terminal devices 1a is equal to or less than the maximum distance over which communication can be performed by Bluetooth (registered trademark), and perform communication by the LPWA communication scheme in a case where the distance between the terminal devices 1a is longer than the maximum distance over which communication can be performed by Bluetooth (registered trademark). Moreover, in FIG. 12, the second wireless communication unit 17 is provided separately from the first wireless communication unit 11a, but in a case where the first wireless communication unit 11a can perform the communication between the terminal devices 1a, the second wireless communication unit 17 need not be provided, and the first wireless communication unit 11a may additionally have the function of the second wireless communication unit 17. Furthermore, the communication between the terminal devices 1a may be performed via the base station 2a. In a case where the second wireless communication unit 17 is used, the terminal device 1a can perform processing related to resource sharing, which will be described later, before connecting to the base station 2a, and when the second wireless communication unit 17 uses the communication scheme with low power consumption, the processing related to resource sharing can be performed with reduced power consumption.

The resource adjustment unit 18 manages the radio resource of the terminal device 1a. For example, when receiving a request for acquisition of resource information, which indicates the status of use of the radio resource, from any of the other ones of the terminal devices 1a via the second wireless communication unit 17, the resource adjustment unit 18 calculates a surplus amount of the radio resource by using the allocation result received from the first wireless communication unit 11a and a used amount acquired from the application processing unit 13 and indicating the amount of the radio resource used by the application that is running. The resource adjustment unit 18 outputs the resource information indicating the surplus amount of the radio resource to the second wireless communication unit 17. The surplus amount is calculated by subtracting the used amount from an allocated amount so that in a case where the allocated amount is larger than the used amount, the surplus amount is a positive value, and in a case where the allocated amount is smaller than the used amount, the surplus amount is a negative value. In addition, when receiving a request for sharing of the radio resource from any of the other ones of the terminal devices 1a via the second wireless communication unit 17, the resource adjustment unit 18 determines an amount of sharing of the radio resource on the basis of the request, and transmits the determined result to the terminal device 1a that has made the request for sharing via the second wireless communication unit 17. Furthermore, the resource adjustment unit 18 transmits the determined result to the base station 2a via the first wireless communication unit 11a.

Note that the surplus amount presented as the resource information may be a value obtained by subtracting a certain amount from the value obtained by subtracting the used amount from the allocated amount, instead of the value obtained by subtracting the used amount from the allocated amount. The certain amount may be determined in advance, or can be set by a user, for example. This can prevent a decrease in the communication speed of the terminal device 1a that transmits the resource information in a case where the used amount of the radio resource in the terminal device 1a increases from the time when the resource information is generated. Moreover, the surplus amount presented as the resource information may be a value obtained by multiplying the value, which is obtained by subtracting the used amount from the allocated amount, by a predetermined ratio less than one.

FIG. 13 is a diagram illustrating an exemplary configuration of the base station 2a of the present embodiment. As illustrated in FIG. 13, the base station 2a is similar to the base station 2 of the first embodiment except that a communication control unit 22a is included instead of the communication control unit 22 of the base station 2 of the first embodiment.

The communication control unit 22a allocates the radio resources for communication between the base station 2a and the communication devices accommodated by the base station 2a. The radio resources allocated by the communication control unit 22a need only be at least either time or band used in the wireless communication, and, hereinafter, an example of allocating the band as the radio resources will be described. In the case where the terminal device 1a requests the allocation of the band, a request value may be the band itself or the communication speed corresponding to the band.

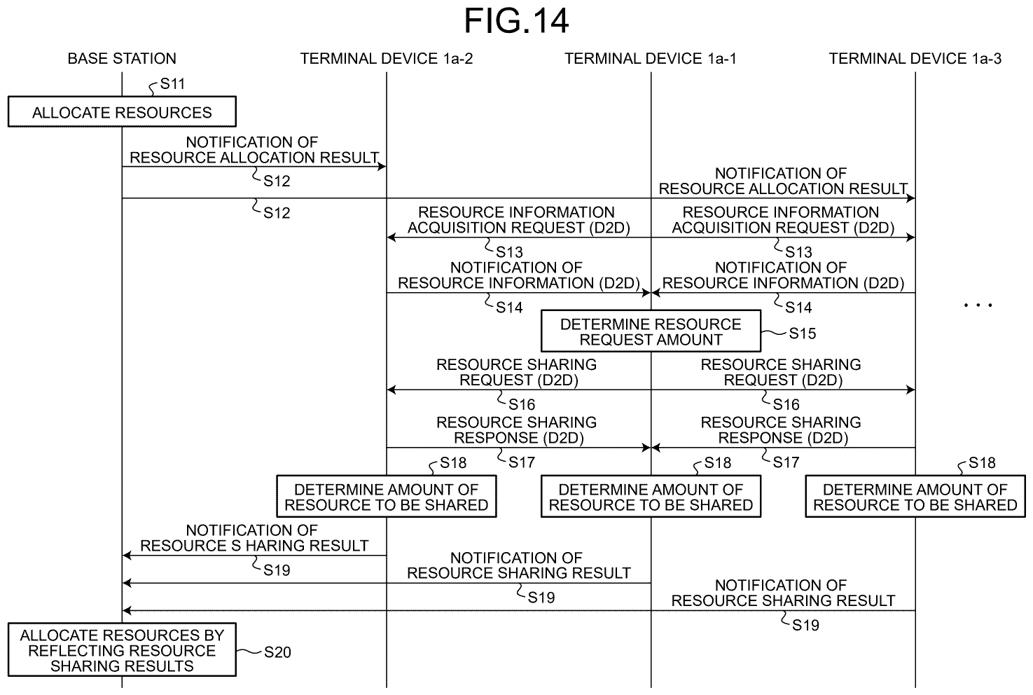

Next, the resource sharing processing of the present embodiment will be described. FIG. 14 is a sequence diagram illustrating an example of the resource sharing processing of the present embodiment. The example illustrated in FIG. 14 assumes that the radio resources have already been allocated to the terminal devices 1a-2 and 1a-3 illustrated in FIG. 11 from the base station 2a. The example also assumes that the terminal device 1a-1 illustrated in FIG. 11 has not performed processing to connect to the base station 2a.

The base station 2a performs resource allocation (step S11), and notifies the terminal devices 1a-2 and 1a-3 of an allocation result, that is, a resource allocation result (step S12). The base station 2a may perform the resource allocation by any method such as a method of equally allocating the band to the communication devices accommodated, an allocation method of periodically receiving a request amount of the resource to be allocated from the communication devices and performing allocation in accordance with the request amount, or another method.

For example, when starting communication using the base station 2a, the user of the terminal device 1a-1 transmits a resource information acquisition request by the communication between the terminal devices 1a (D2D) (step S13). Specifically, the resource adjustment unit 18 of the terminal device 1a-1 generates the resource information acquisition request for requesting acquisition of the resource information and outputs the resource information acquisition request to the second wireless communication unit 17, and the second wireless communication unit 17 transmits the resource information acquisition request by broadcast.

The terminal devices 1a-2 and 1a-3 that have received the resource information acquisition request notify the terminal device 1a-1 of the resource information (step S14). Specifically, when receiving the resource information acquisition request from the terminal device 1a-1, the second wireless communication unit 17 of each of the terminal devices 1a-2 and 1a-3 outputs the resource information acquisition request received to the resource adjustment unit 18, and the resource adjustment unit 18 having received the resource information acquisition request calculates the surplus amount using the allocation result by the base station 2a and the used amount by the application as described above. The resource adjustment unit 18 generates the resource information including the surplus amount, and outputs the resource information generated to the second wireless communication unit 17. The resource information may include the location information of the terminal device 1a. The second wireless communication unit 17 of each of the terminal devices 1a-2 and 1a-3 transmits the resource information to the terminal device 1a-1.

The terminal device 1a-1 determines a resource request amount that is the amount of resource requested to be shared (step S15). Specifically, the second wireless communication unit 17 of the terminal device 1a-1 having received the resource information receives the resource information from the terminal devices 1a-2 and 1a-3 and outputs the resource information received to the resource adjustment unit 18, and the resource adjustment unit 18 uses the resource information to determine the resource request amount for each of the terminal devices 1a from which the resource information has been transmitted. For example, the maximum value of a total value of the resource request amounts is determined in advance, and when the total value of the positive values of the surplus amounts in the resource information received from the terminal devices 1a-2 and 1a-3 is equal to or less than the maximum value, the resource adjustment unit 18 determines the resource request amount for the terminal device 1a having the surplus amount of the positive value to be the surplus amount of the terminal device 1a.

Also, each of the terminal devices 1a may include information indicating a unit price of the resource in the resource information, and the resource adjustment unit 18 may determine the resource request amount in consideration of the unit price in addition to the surplus amount. The unit price may be, for example, set by the user or determined by an administrator who manages the operation of sharing of the radio resources. For example, in a case where the unit price is a predetermined threshold or higher, the resource request amount for the corresponding terminal device 1a may be determined to be zero, or the resource request amount for the terminal device 1a may be determined such that the lower the unit price, the larger the resource amount requested. In addition, the maximum value of the total value of the resource request amounts need not always be determined in advance, and the resource adjustment unit 18 of the terminal device 1a-1 may determine the maximum value of the total value of the resource request amounts on the basis of the communication speed corresponding to the application running (the communication speed required for the application to operate normally when the application is started). The communication speed corresponding to each application may be determined in advance, may adopt a value disclosed by a vendor providing each application or the like, or may be determined in advance using an actual value of the communication speed when the application is started on the terminal device 1a.

Moreover, the resource adjustment unit 18 of the terminal device 1a-1 may determine the maximum value of the total value of the resource request amounts by input from the user, or may determine the resource request amount for each of the terminal devices 1a by input from the user. For example, the resource adjustment unit 18 may output the resource information to the display control unit 14, and the display control unit 14 may cause the information display unit 16 to display the resource information. For example, the display control unit 14 may cause the information display unit 16 to superimpose and display the surrounding information and the information indicating the radio field intensity, which are described in the first embodiment, and the resource information.

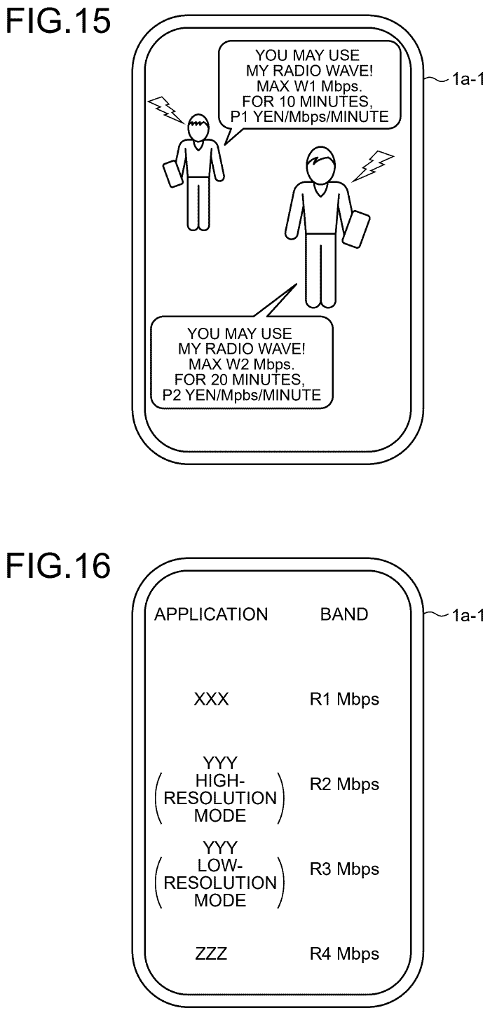

FIG. 15 is a diagram illustrating an exemplary display of the resource information of the present embodiment. In the example illustrated in FIG. 15, the surrounding information and the information indicating the radio field intensity described in the first embodiment and the resource information are superimposed. In the example illustrated in FIG. 15, the resource information includes the surplus amount, the duration of use, and the unit price where the surplus amount is represented by the communication speed, and the unit price is represented as a price per unit band and unit time. The duration of use is set by, for example, the user of the corresponding terminal device 1a-1. Note that the resource information need only include the surplus amount, and need not include the duration of use and the unit price. The user checks the resource information, determines the maximum value of the total value of the resource request amounts, and inputs the maximum value to the terminal device 1a-1 using the input receiving unit (not illustrated). The resource adjustment unit 18 may then use the maximum value of the total value of the resource request amounts received from the user to determine the resource request amount for each of the terminal devices 1a as described above. Alternatively, the user may check the resource information, determine the resource request amount for each of the terminal devices 1a, and input the resource request amount to the terminal device 1a-1 using the input receiving unit (not illustrated).

Furthermore, the communication speed for each application may be displayed such that the user can refer thereto in determining the maximum value of the total value of the resource request amounts, the resource request amount for each of the terminal devices 1a, and the like described above. FIG. 16 is a diagram illustrating an exemplary display of the communication speed for each application of the present embodiment. FIG. 16 also illustrates the communication speed for each mode in a case where the communication speed varies depending on the mode in a single application. For example, the resource adjustment unit 18 outputs the communication speed for each application to the display control unit 14, and the display control unit 14 causes the information display unit 16 to display the communication speed for each application. As a result, the user can determine the maximum value of the total value of the resource request amounts or the resource request amount for each of the terminal devices 1a in consideration of the communication speed corresponding to the application to be used. Moreover, the user can check both the resource information illustrated in FIG. 15 and the communication speed for each application illustrated in FIG. 16, and when the surplus amount is small, the user can limit the application to be used to an application with a low communication speed or set the mode to a mode with a low communication speed.

The description refers back to FIG. 14. After step S15, the terminal device 1a-1 transmits a resource sharing request indicating that the sharing of the radio resource is requested to each of the terminal devices 1a-2 and 1a-3 by the communication between the terminal devices 1a (step S16). Specifically, the resource adjustment unit 18 of the terminal device 1a-1 generates the resource sharing requests including the resource request amounts for the corresponding terminal devices 1a-2 and 1a-3, and transmits the resource sharing requests to the corresponding terminal devices 1a-2 and 1a-3 via the second wireless communication unit 17. In the example illustrated in FIG. 14, in order to request both of the terminal devices 1a-2 and 1a-3 to share the radio resources, the terminal device 1a-1 transmits the resource sharing request to both of the terminal devices 1a-2 and 1a-3, but the resource sharing request need not be transmitted to the terminal device 1a not requested to share the radio resource, or may be transmitted thereto with the resource request amount set to zero.

Upon receiving the resource sharing request, each of the terminal devices 1a-2 and 1a-3 transmits a resource sharing response to the terminal device 1a-1 by the communication between the terminal devices 1a (step S17). Specifically, the second wireless communication unit 17 of each of the terminal devices 1a-2 and 1a-3 receives the resource sharing request from the terminal device 1a-1, and outputs the resource sharing request received to the resource adjustment unit 18. When the resource request amount requested by the resource sharing request can be shared, the resource adjustment unit 18 generates the resource sharing response indicating that the resource request amount requested can be shared, and outputs the resource sharing response to the second wireless communication unit 17, and then the second wireless communication unit 17 transmits the resource sharing response to the terminal device 1a-1. Note that when the resource request amount requested by the resource sharing request cannot be shared, the resource adjustment unit 18 generates the resource sharing response indicating that the resource request amount requested cannot be shared, and outputs the resource sharing response to the second wireless communication unit 17, and then the second wireless communication unit 17 transmits the resource sharing response to the terminal device 1a-1.

For example, in a case where the resource request amount requested is equal to or less than the surplus amount, the terminal devices 1a-2 and 1a-3 determine that the resource request amount requested can be shared. In a case where the resource request amount requested exceeds the surplus amount due to a sudden change in the status of use of the radio resource after the transmission of the resource information, the resource sharing response indicating that the resource request amount requested cannot be shared may be transmitted. Even in the case where the resource request amount requested exceeds the surplus amount due to a sudden change in the status of use of the radio resource after the transmission of the resource information, the terminal devices 1a-2 and 1a-3 may determine that the resource request amount requested by the resource sharing request can be shared. In this case, the terminal device 1a that shares the radio resource experiences a decrease in the communication speed but can obtain compensation if the sharing is charged. Note that under what condition the terminal devices 1a-2 and 1a-3 determine that the resource request amount can be shared may be set by the user.

The terminal devices 1a-1 to 1a-3 each determine an amount of resource to be shared (step S18). Specifically, in a case where the resource adjustment unit 18 of each of the terminal devices 1a-2 and 1a-3 transmits the resource sharing response indicating that the resource request amount requested can be shared, the resource adjustment unit 18 of each of the terminal devices 1a-2 and 1a-3 sets the resource request amount requested from the terminal device 1a-1 as the amount of resource to be shared corresponding to the terminal device 1a-1. In a case where the resource adjustment unit 18 of each of the terminal devices 1a-2 and 1a-3 transmits the resource sharing response indicating that the resource request amount requested cannot be shared, the resource adjustment unit 18 of each of the terminal devices 1a-2 and 1a-3 sets the amount of resource to be shared corresponding to the terminal device 1a-1 to zero. In a case where the resource adjustment unit 18 of the terminal device 1a-1 receives the resource sharing response, which indicates that the resource request amount requested can be shared, via the second wireless communication unit 17, the resource adjustment unit 18 of the terminal device 1a-1 determines the corresponding resource request amount as the amount of resource to be shared that is provided from the terminal device 1a from which the resource sharing response is transmitted.

The terminal devices 1a-1 to 1a-3 each notify the base station 2a of a resource sharing result (step S19). Specifically, the resource adjustment unit 18 of each of the terminal devices 1a-1 to 1a-3 transmits the resource sharing result to the base station 2a via the first wireless communication unit 11a. The resource sharing result includes, for example, a combination of the terminal device 1a by which the radio resource is provided and the terminal device 1a to which the radio resource is provided, and the amount of resource to be shared corresponding to each combination. Note that, in the example illustrated in FIG. 14, the terminal device 1a-2 only needs to notify the base station 2a of the resource sharing result regarding the combination of the terminal device 1a-2 as the source of the radio resource and the terminal device 1a-1 as the destination of the radio resource, and the terminal device 1a-3 only needs to notify the base station 2a of the resource sharing result regarding the combination of the terminal device 1a-3 as the source of the radio resource and the terminal device 1a-1 as the destination of the radio resource. The terminal device 1a-1 notifies the base station 2a of the resource sharing result corresponding to both the combination of the terminal device 1a-2 as the source of the radio resource and the terminal device 1a-1 as the destination of the radio resource, and the combination of the terminal device 1a-3 as the source of the radio resource and the terminal device 1a-1 as the destination of the radio resource.

Note that, in FIG. 14, the terminal devices 1a-1 to 1a-3 notify the base station 2a of the resource sharing results, but the resource sharing result transmitted by the terminal device 1a-1 is a combination of the resource sharing result transmitted by the terminal device 1a-2 and the resource sharing result transmitted by the terminal device 1a-3, so that either the terminal device 1a-1 or the terminal device 1a-2 and the terminal device 1a-3 may notify the base station 2a of the resource sharing results. Note that, in a case where the terminal device 1a-1 notifies the base station 2a of the resource sharing result, the notification is performed after the processing to connect to the base station 2a is performed.

The base station 2a having received the resource sharing results performs resource allocation reflecting the resource sharing results (step S20). Notification of a resource allocation result reflecting the resource sharing results is sent to the terminal devices 1a-1 to 1a-3, and from then on, communication based on the resource allocation result reflecting the resource sharing results is performed.

Note that in a case where the terminal device 1a-1 receives the resource sharing response indicating that the resource request amount requested cannot be shared in step S17, the terminal device 1a-1 may notify the display control unit 14 to that effect, and the display control unit 14 may cause the information display unit 16 to display that resource sharing cannot be performed. The user who has seen this display may move to another location and perform the processing from step S13 again. In addition, in a case where resource sharing cannot be performed, the terminal device 1a-1 may perform communication with the base station 2a according to a normal procedure and receive the allocation of the radio resource from the base station 2a.

Moreover, in the example illustrated in FIG. 14, the terminal device 1a-1 performs step S13 before receiving the allocation of the radio resource from the base station 2a, but may perform step S13 to further use the radio resource after the allocation of the radio resource from the base station 2a. In this case, in step S15, the total value of the resource request amounts may be calculated on the basis of a difference between the radio resource (communication speed) allocated to the terminal device 1a-1 and the communication speed corresponding to the application being used.

Moreover, in the example described above, the terminal device 1a-1 that requests to receive the provision of the radio resource requests the acquisition of the resource information for notification of the surplus amount to the other ones of the terminal devices 1a, but in a case where the surplus amount is large or the like, the terminal device 1a-1 may request the acquisition of the resource information for notification of a necessary amount of the radio resource. For example, when the surplus amount is equal to or larger than a threshold, the terminal device 1a-1 may transmit the request to acquire the resource information for notification of the necessary amount to the other ones of the terminal devices 1a. Upon receiving the resource information including the necessary amount, the terminal device 1a-1 determines the resource request amount as an amount of resource to be provided by using the necessary amount included in the resource information, and transmits the resource sharing request including the resource request amount determined to the other ones of the terminal devices 1a. Then, the other ones of the terminal devices 1a each transmit the resource sharing response indicating to receive the provision of the resource request amount included in the resource sharing request, so that the resource sharing result is determined, and the base station 2a is notified of the resource sharing result and performs resource allocation reflecting the resource sharing result. In this case, the resource information may include the unit price paid for the sharing of the radio resource, and the terminal device 1a-1 may determine the resource request amount in consideration of the unit price. Note that, as described above, the resource is insufficient in a case where the surplus amount included in the resource information is negative, in which case an absolute value of the surplus amount may be used as the necessary amount.

That is, in a case where there is a plurality of the terminal devices 1a including a first terminal device and a second terminal device, the first terminal device need only transmit, to the second terminal device, the resource information acquisition request for requesting notification of the surplus amount or the necessary amount of the radio resource usable between the second terminal device and the base station 2a. The first terminal device is the terminal device 1a-1 in the example illustrated in FIG. 14, and the second terminal device is the terminal devices 1a-2 and 1a-3 in the example illustrated in FIG. 14, but the number of the second terminal devices is not limited to this example and may be one or more. When receiving the resource information acquisition request, the second terminal device transmits the resource information including the surplus amount or the necessary amount to the first terminal device.

The first terminal device uses the resource information to determine the resource request amount, which is the amount of the radio resource requested to be transferred to or from the second terminal device, and transmits the resource request amount to the second terminal device. The transfer is the provision of the radio resource from the second terminal device to the first terminal device in a case where the resource information includes the surplus amount, or is the provision of the radio resource from the first terminal device to the second terminal device in a case where the resource information includes the necessary amount. When the resource request amount can be transferred to or from the first terminal device, the second terminal device transmits a response (resource sharing response) indicating that the transfer can be performed to the first terminal device. The first terminal device and the second terminal device determine a resource amount to be shared that is a radio resource amount transferred between the first terminal device and the second terminal device. Then, at least one of the first terminal device and the second terminal device notifies the base station 2a of the resource amount to be shared.

In addition, the first terminal device may communicate with the second terminal device by the short-range wireless communication scheme when capable of communicating with the second terminal device by the short-range wireless communication scheme, or may communicate with the second terminal device by the LPWA communication scheme when not capable of communicating with the second terminal device by the short-range wireless communication scheme. Furthermore, although not illustrated in FIG. 11, a relay device capable of performing one-to-one communication with each of the first terminal device and the second terminal device may be included. The first terminal device may communicate with the second terminal device by the short-range wireless communication scheme when capable of communicating with the second terminal device by the short-range wireless communication scheme, or may communicate with the second terminal device via the relay device when not capable of communicating with the second terminal device by the short-range wireless communication scheme.

Note that, in a case where the sharing of the radio resource is charged, the fee for the sharing of the radio resource may be paid by any method such as a method in which, in a case where a communication service using the base station 2a is charged, the fee for the sharing is paid together with a fee related to the communication service. Note that in the example described above, the terminal device 1a that performs the resource sharing processing described in the present embodiment also has the function of displaying the radio field intensity described in the first embodiment, but the terminal device 1a that performs the resource sharing processing described in the present embodiment need not have the function of displaying the radio field intensity described in the first embodiment. That is, the terminal device 1a need not include the radio field intensity information generating unit 12. Also, in this case, the base station 2a need not include the intensity map generation unit 23.

Hardware configurations of the terminal device 1a and the base station 2a of the present embodiment are similar to the hardware configurations of the terminal device 1 and the base station 2 of the first embodiment. The first wireless communication unit 11a and the second wireless communication unit 17 illustrated in FIG. 12 are implemented by the communication unit 105 illustrated in FIG. 10, and the resource adjustment unit 18 illustrated in FIG. 12 is implemented when the control unit 101 illustrated in FIG. 10 executes the computer program stored in the storage unit 103 illustrated in FIG. 10. The resource adjustment unit 18 illustrated in FIG. 12 is implemented by also using the storage unit 103 illustrated in FIG. 10. The communication control unit 22a of the base station 2a is implemented by the control unit 101 illustrated in FIG. 10, as with the communication control unit 22 of the first embodiment.

As described above, in the present embodiment, the terminal device 1a acquires the resource information indicating the surplus amount of the radio resource from the other ones of the terminal devices 1a and determines the terminal device 1a to which the sharing of the resource is requested by using the resource information, and the terminal device 1a to which the sharing of the resource has been requested shares the resource on the basis of the request. As a result, the radio resource can be used effectively.

The configurations illustrated in the above embodiments each illustrate an example so that another known technique can be combined, the embodiments can be combined together, or the configurations can be partially omitted and/or modified without departing from the scope of the present disclosure.

### REFERENCE SIGNS LIST

1, 1-1 to 1-3, 1a, 1a-1 to 1a-3 terminal device; 2, 2a base station; 3 electrical equipment; 11, 21 wireless communication unit; 11a first wireless communication unit; 12 radio field intensity information generating unit; 13 application processing unit; 14 display control unit; 15 surrounding information acquisition unit; 16 information display unit; 17 second wireless communication unit; 18 resource adjustment unit; 22, 22a communication control unit; 23 intensity map generation unit; 24 inter-base station communication unit; 100, 100a communication system.

1.-3. (canceled)

4. A communication system comprising:
one or more communication devices capable of performing wireless communication;
a first terminal; and
a second terminal, wherein
the first terminal transmits, to the second terminal, a resource information acquisition request that requests notification of a surplus amount or a necessary amount of a radio resource usable between the second terminal and the communication devices, and
the second terminal receives the resource information acquisition request and transmits, to the first terminal, resource information including the surplus amount or the necessary amount.

5. The communication system according to claim 4, wherein
the first terminal uses the resource information to determine a resource request amount that is an amount of the radio resource requested to be transferred to or from the second terminal, and transmits the resource request amount to the second terminal,
the second terminal transmits a response that indicates that the resource request amount can be transferred, to the first terminal in a case where the resource request amount can be transferred to or from the first terminal,
the first terminal and the second terminal determine a resource amount to be shared that is an amount of the radio resource transferred between the first terminal and the second terminal, and
at least one of the first terminal or the second terminal notifies the communication devices of the resource amount to be shared.

6. The communication system according to claim 4, wherein the second terminal includes a plurality of the second terminals.

7. The communication system according to claim 4, wherein communication between the first terminal and the second terminal is performed by another communication scheme different from that of communication between the first terminal and the communication devices.

8. The communication system according to claim 7, wherein
the another communication scheme includes a short-range wireless communication scheme and a low power wide area communication scheme, and
the first terminal communicates with the second terminal by the short-range wireless communication scheme when capable of communicating with the second terminal by the short-range wireless communication scheme, or communicates with the second terminal by the low power wide area communication scheme when not capable of communicating with the second terminal by the short-range wireless communication scheme.

9. The communication system according to claim 7, comprising
a relay capable of performing one-to-one communication with each of the first terminal and the second terminal, wherein
the another communication scheme includes a short-range wireless communication scheme, and
the first terminal communicates with the second terminal by the short-range wireless communication scheme when capable of communicating with the second terminal by the short-range wireless communication scheme, or communicates with the second terminal via the relay when not capable of communicating with the second terminal by the short-range wireless communication scheme.

10. A communication system comprising:
a base station; and
a plurality of terminals including a first terminal and a second terminal, wherein
the first terminal transmits, to the second terminal, a resource information acquisition request that requests notification of a surplus amount of a radio resource usable between the second terminal and the base station,
the second terminal receives the resource information acquisition request and transmits, to the first terminal, resource information including the surplus amount,
the first terminal uses the resource information to determine a resource request amount that is an amount of the radio resource requested to be provided from the second terminal, and transmits the resource request amount to the second terminal,
the second terminal transmits a response that indicates that the resource request amount can be provided to the first terminal, to the first terminal when capable of providing the resource request amount to the first terminal,
the first terminal and the second terminal determine, on the basis of the response, a resource amount to be shared that is an amount of the radio resource to be provided from the second terminal to the first terminal, and
at least one of the first terminal or the second terminal notifies the base station of the resource amount to be shared.

11.-14. (canceled)

15. The communication system according to claim 5, wherein the second terminal includes a plurality of the second terminals.

16. The communication system according to claim 5, wherein communication between the first terminal and the second terminal is performed by another communication scheme different from that of communication between the first terminal and the communication devices.

17. A communication method in a communication system including one or more communication devices capable of performing wireless communication, a first terminal, and a second terminal, the communication method comprising:
transmitting, by the first terminal, to the second terminal, a resource information acquisition request that requests notification of a surplus amount or a necessary amount of a radio resource usable between the second terminal and the communication devices; and
receiving, by the second terminal, the resource information acquisition request, and transmitting, by the second terminal, to the first terminal, resource information including the surplus amount or the necessary amount.
